(19) United States
(12) Patent Application Publication
(10) Pub. No.: US 2018/0275742 A1
(43) Pub. Date: Sep. 27, 2018

(54) APPARATUS AND METHOD FOR CONTROLLING GOVERNOR BASED ON HETEROGENEOUS MULTICORE SYSTEM

(71) Applicant: Electronics and Telecommunications Research Institute, Daejeon (KR)

(72) Inventors: Jin-Ho SEOL, Sejong (KR); Jeong-Si KIM, Daejeon (KR); Gap-Joo NA, Daejeon (KR); Chae-Deok LIM, Daejeon (KR); Yung-Joon JUNG, Daejeon (KR)

(21) Appl. No.: 15/690,164

(22) Filed: Aug. 29, 2017

(30) Foreign Application Priority Data
Mar. 23, 2017 (KR) 10-2017-0036931

(51) Int. Cl. G06F 1/32; G06F 9/48; G06F 9/50

(52) U.S. Cl. CPC G06F 1/3293; G06F 9/4893; G06F 1/324; G06F 1/3206; G06F 9/5094

(57) ABSTRACT

Disclosed herein are an apparatus and method for controlling a governor based on a heterogeneous multicore system. The apparatus includes a heterogeneous core cluster unit for running any one of a first core cluster for high-performance operation and a second core cluster for low-power operation by switching therebetween; a governor-setting unit for generating operation setting information of a governor for controlling operation of the first core cluster and second core cluster; and a governor control unit for controlling operation of one or more governors based on the operation setting information.

### CROSS REFERENCE TO RELATED APPLICATION

This application claims the benefit of Korean Patent Application No. 10-2017-0036931, filed Mar. 23, 2017, which is hereby incorporated by reference in its entirety into this application.

### BACKGROUND OF THE INVENTION

### 1. Technical Field

The present invention relates generally to technology for controlling heterogeneous multicore systems, and more particularly to technology for controlling core-cluster switching using a governor.

### 2. Description of the Related Art

With the development of hardware, manufacturing processes have been refined, and Systems-on-Chip (SoCs) having a smaller form factor have been developed. However, because the amount of power consumed per core cannot be reduced any further, portions of a chip have to be kept switched off at desired times, that is, a “dark silicon” problem is caused. In order to solve this problem, heterogeneous multicore processors, configured such that a high-performance core and a low-power core are integrated into a single chip, have been released. A representative one thereof is a ‘big.LITTLE’ structure employed by ARM, and it contains both a cluster of ‘big’ cores, which are high-performance cores, and a cluster of ‘LITTLE’ cores, which are low-power cores.

There are three usage models pertaining to how the big-core cluster and the little-core cluster are used. The first one is a cluster-switching model, in which either the big-core cluster or the LITTLE-core cluster is activated and used at any given time. The second one is a core-switching model. In the core-switching model, a core included in the big-core cluster makes a pair with a core included in the LITTLE-core cluster, the pair runs as a single virtual core, and a big core or a LITTLE core of each virtual core actually runs depending on a load. The final one is a multicore processing model, in which both a big core and a LITTLE core simultaneously run.

In multicore systems, Dynamic Voltage Frequency Scaling (DVFS) is used for power management. Particularly in Linux, different types of governors are present for power management based on DVFS. Governors may determine whether to increase or decrease a frequency based on CPU information according to some policy. As the different types of governors, there are a performance governor for running a CPU with the highest performance, a powersave governor for reducing power consumption to a minimum by running a CPU at the lowest frequency, an ondemand governor for dynamically regulating an operating frequency depending on whether a CPU load is increased or decreased, an interactive governor for improving responsiveness to user input, a conservative governor for decreasing the responsiveness compared to a request mode and for saving energy, and the like.

A governor sets a frequency based on CPU-related information and delivers it to a frequency driver. The frequency driver receives it, and may instruct actual hardware to change a frequency. Frequency drivers generally produced by hardware manufacturers are responsible for changing the frequency of a core using special commands. However, if a structure using a general governor and frequency driver is used in a heterogeneous multicore system, a problem may occur. When the cluster-switching model is used in the heterogeneous multicore system, the operation of a frequency driver is changed. When a frequency is set high, the frequency driver activates the big-core cluster but deactivates the little-core cluster, which causes a cluster switch. Conversely, when a frequency is set low, the frequency driver activates the little-core cluster but deactivates the big-core cluster, which causes a cluster switch. As a result, the following problems may be caused in the cluster-switching model. First, because a governor is not aware of the heterogeneous multicore system, if the governor frequently changes a frequency, switching between clusters frequently occurs, which results in performance degradation. Second, because a governor is produced for a single purpose, if a governor having a single purpose, such as a governor for high performance or a governor for power savings, is run in the cluster-switching model, in which cores are divided into a big-core cluster for high performance and a little-core cluster for power savings, it is difficult to make use of the advantages of the hardware configuration. Finally, because the existing governor model determines a frequency scaling policy using only CPU-related information, it has a limitation in that different results based on various kinds of information may not be acquired.

Meanwhile, Korean Patent Application Publication No. 10-2013-0141218, titled “Multi-cluster processing system and method for operating the system” discloses a multi-cluster processing system and a method for operating the multi-cluster processing system, which enables or disables a core based on the usage efficiency of the core in order to reduce the amount of power consumed by a multi-core processor.

However, Korean Patent Application Publication No. 10-2013-0141218 has a limitation in which various kinds of results may not be achieved because the multi-core system is controlled based on only core usage efficiency, which is the CPU-related information, in order to reduce the power consumption.

### SUMMARY OF THE INVENTION

An object of the present invention is to efficiently control and manage multiple governors using various kinds of information.

Another object of the present invention is to improve the performance of a multicore system by minimizing the number of operations for switching between core clusters.

A further object of the present invention is to reduce the amount of power consumed by a multicore system by minimizing the number of operations for switching between core clusters.

In order to accomplish the above objects, an apparatus for controlling a governor based on a heterogeneous multicore system according to an embodiment of the present invention includes a heterogeneous core cluster unit for running any one of a first core cluster for high-performance operation and a second core cluster for low-power operation by switching therebetween; a governor-setting unit for generating operation setting information of a governor for controlling operation of the first core cluster and the second core cluster; and a governor control unit for controlling operation of one or more governors based on the operation setting information.

Here, the governor-setting unit may generate the operation setting information in which at least one of a precedence value, an operation condition, an operation governor, a maximum frequency, and a minimum frequency is set.

Here, the governor-setting unit may set the precedence value on the operation conditions for at least one of an operation mode set by a user, a remaining capacity of a battery, information about whether a power supply is connected, information about whether an application is running, and information about whether a display is turned on.

Here, the governor-setting unit may set the maximum frequency and the minimum frequency on each of the operation conditions, the precedence value of which is set.

Here, the governor control unit may determine an operation condition depending on the precedence value set in the operation setting information and run an operation governor corresponding to the operation condition.

Here, the governor control unit may control any one of the first core cluster and the second core cluster at between the maximum frequency and the minimum frequency by running the operation governor corresponding to the operation condition.

Here, when two or more operation conditions have an identical precedence value, the governor control unit may simultaneously run operation governors corresponding to the two or more operation conditions and set a final frequency according to a frequency integration policy.

Here, when two or more operation conditions have an identical precedence value, the governor control unit may set a maximum value of maximum frequencies of the two or more operation conditions and a minimum value of minimum frequencies of the two or more operation conditions as final frequencies according to the frequency integration policy.

Here, when two or more operation conditions have an identical precedence value, the governor control unit may set a maximum value of maximum frequencies of the two or more operation conditions and a maximum value of minimum frequencies of the two or more operation conditions as final frequencies according to the frequency integration policy.

Here, when two or more operation conditions have an identical precedence value, the governor control unit may set an average of maximum frequencies of the two or more operation conditions and an average of minimum frequencies of the two or more operation conditions as final frequencies according to the frequency integration policy.

Also, in order to accomplish the above objects, a method for controlling a governor based on a heterogeneous multicore system, in which an apparatus for controlling a governor based on a heterogeneous multicore system is used, according to an embodiment of the present invention includes generating operation setting information of a governor for controlling operation of a first core cluster and a second core cluster of a heterogeneous core cluster; controlling operation of one or more governors based on the operation setting information; and running any one of the first core cluster for high-performance operation and the second core cluster for low-power operation by switching therebetween by controlling the operation of the one or more governors.

Here, generating the operation setting information may be configured to generate the operation setting information in which at least one of a precedence value, an operation condition, an operation governor, a maximum frequency, and a minimum frequency is set.

Here, generating the operation setting information may be configured to set the precedence value on the operation conditions for at least one of an operation mode set by a user, a remaining capacity of a battery, information about whether a power supply is connected, information about whether an application is running, and information about whether a display is turned on.

Here, generating the operation setting information may be configured to set the maximum frequency and the minimum frequency on each of the operation conditions, the precedence value of which is set.

Here, controlling the operation may be configured to determine an operation condition depending on the precedence value set in the operation setting information and to run an operation governor corresponding to the operation condition.

Here, controlling the operation may be configured to control any one of the first core cluster and the second core cluster at between the maximum frequency and the minimum frequency by running the operation governor corresponding to the operation condition.

Here, controlling the operation may be configured such that, when two or more operation conditions have an identical precedence value, operation governors corresponding to the two or more operation conditions are simultaneously run and a final frequency is set according to a frequency integration policy.

Here, controlling the operation may be configured such that, when two or more operation conditions have an identical precedence value, a maximum value of maximum frequencies of the two or more operation conditions and a minimum value of minimum frequencies of the two or more operation conditions are set as final frequencies according to the frequency integration policy.

Here, controlling the operation may be configured such that, when two or more operation conditions have an identical precedence value, a maximum value of maximum frequencies of the two or more operation conditions and a maximum value of minimum frequencies of the two or more operation conditions are set as final frequencies according to the frequency integration policy.

Here, controlling the operation may be configured such that, when two or more operation conditions have an identical precedence value, an average of maximum frequencies of the two or more operation conditions and an average of minimum frequencies of the two or more operation conditions are set as final frequencies according to the frequency integration policy.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows an apparatus for controlling a governor based on a heterogeneous multicore system according to an embodiment of the present invention;

FIG. 2 is a view that shows the control of frequencies of a core cluster according to an embodiment of the present invention;

FIG. 3 is a block diagram that specifically shows an example of the governor control unit illustrated in FIG. 1;

FIG. 4 is a block diagram that specifically shows an example of the heterogeneous core cluster unit illustrated in FIG. 1;

FIG. 5 is a flowchart that shows a method for controlling a governor based on a heterogeneous multicore system according to an embodiment of the present invention; and

FIG. 6 is an embodiment of the present invention implemented in a computer system.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present invention will be described in detail with reference to the accompanying drawings.

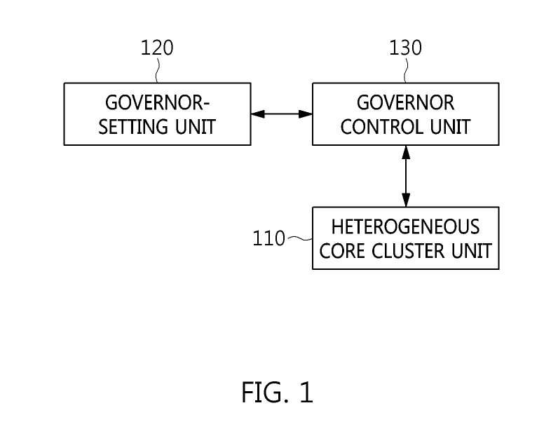

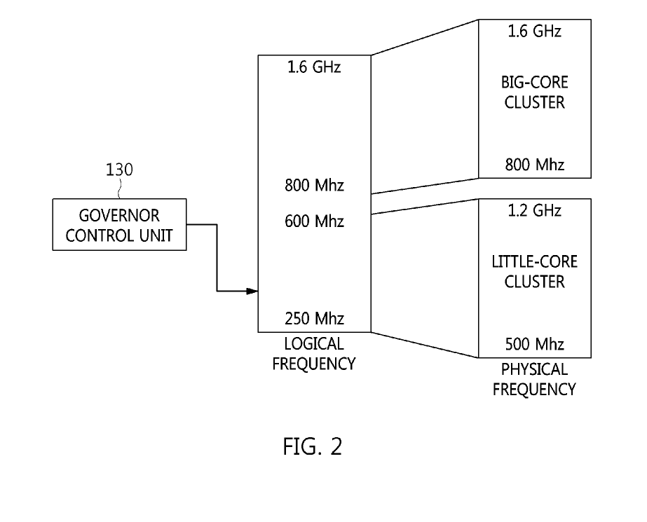

FIG. 1 is a block diagram that shows an apparatus for controlling a governor based on a heterogeneous multicore system according to an embodiment of the present invention. FIG. 2 is a view that shows the control of frequencies of a core cluster according to an embodiment of the present invention.

Referring to FIG. 1, an apparatus for controlling a governor based on a heterogeneous multicore system according to an embodiment of the present invention includes a heterogeneous core cluster unit 110, a governor-setting unit 120 and a governor control unit 130.

The heterogeneous core cluster unit 110 may run any one of a first core cluster for high-performance operation and a second core cluster for low-power operation by switching therebetween.

Here, the heterogeneous core cluster unit 110 may correspond to a cluster-switching model in which switching between a first core cluster unit 111 and a second core cluster unit 112 can be performed while operations are being performed.

Here, the heterogeneous core cluster unit 110 may include the first core cluster unit 111 and the second core cluster unit 112.

The first core cluster unit 111 may be a big-core cluster.

The first core cluster unit 111 may include multiple cores.

Here, the big-core cluster may include multiple big cores 11, 12, 13 and 14.

Here, the big-core cluster may perform high-performance operation.

The second core cluster unit 112 may be a little-core cluster.

The second core cluster unit 112 may include multiple cores.

Here, the little-core cluster may include multiple little cores 21, 22, 23 and 24.

Here, the little-core cluster may perform low-power operation.

The governor-setting unit 120 may generate operation setting information of a governor for controlling the operation of the first core cluster unit 11 and the second core cluster unit 112.

Here, the governor-setting unit 120 may generate operation setting information in which at least one of a precedence value, an operation condition, an operation governor, a maximum frequency and a minimum frequency is set.

Here, the governor-setting unit 120 may set the precedence values of operation conditions for at least one of an operation mode set by a user, a remaining capacity of a battery, information about whether a power supply is connected, information about whether an application is running, and information about whether a display is turned on.

Here, the governor-setting unit 120 may set the maximum frequency and the minimum frequency on each of the operation conditions, the precedence value of which is set.

Here, the governor-setting unit 120 may receive operation setting information like the following Embodiment 1 from a user.

### Embodiment 1

[precedence value, operation condition, operation governor, maximum frequency, minimum frequency]

The governor control unit 130 may control the operation of one or more governors based on the operation setting information.

Here, the governor control unit 130 may include a governor unit 131, a frequency integration unit 132 and a frequency driver unit 133.

The governor unit 131 may include at least one of a performance governor for running a core with the highest performance, a powersave governor for reducing power consumption to a minimum by running a core at the lowest frequency, an ondemand governor for dynamically regulating a frequency by raising an operating frequency when a CPU load increases but lowering the operating frequency when the CPU load decreases, an interactive governor for improving responsiveness to user input, and a conservative governor for decreasing the responsiveness compared to a request mode and for saving energy.

The frequency integration unit 132 may set the minimum frequency and maximum frequency of the at least one governor selected from the governor unit 131 according to a frequency integration policy.

Here, the frequency integration unit 132 may set the final frequency to a high frequency for performance, a low frequency for saving power, or the average frequency.

The frequency driver unit 133 may run the first core cluster unit 111 and the second core cluster unit 112 of the heterogeneous core cluster unit 110 by controlling the frequency thereof using the final frequency set by the frequency integration unit 132.

Here, the governor control unit 130 may select an operation condition depending on the precedence value set in the operation setting information, and may run an operation governor corresponding to the operation condition.

Here, the governor control unit 130 may run the operation governor corresponding to the operation condition, thereby controlling any one of the first core cluster unit 111 and the second core cluster unit 112 at between the maximum frequency and the minimum frequency.

Here, if two or more operation conditions have the same precedence value, the governor control unit 130 simultaneously runs operation governors corresponding to the two or more operation conditions, and may set the final frequency according to the frequency integration policy.

Here, if two or more operation conditions have the same precedence value, the governor control unit 130 may set the final frequencies to the maximum value of the maximum frequencies of the two or more operation conditions and the minimum value of the minimum frequencies thereof according to the frequency integration policy.

Here, if two or more operation conditions have the same precedence value, the governor control unit 130 may set the final frequencies to the maximum value of the maximum frequencies of the two or more operation conditions and the maximum value of the minimum frequencies thereof according to the frequency integration policy.

Here, if two or more operation conditions have the same precedence value, the governor control unit 130 may set the final frequencies to the average of the maximum frequencies of the two or more operation conditions and the average of the minimum frequencies thereof according to the frequency integration policy.

Referring to FIG. 2, the frequency of a core cluster according to the present invention is controlled in such a way that the big-core cluster is activated when the governor control unit 130 raises the frequency (800 MHz or higher) and that the little-core cluster is activated when the governor control unit 130 lowers the frequency (600 MHz or lower).

For example, the governor control unit 130 may control governors according to operation setting information like the following Embodiment 2.

### Embodiment 2

[100, user mode=high performance, performance, 1600, 1600]

[100, user mode=low-power, powersave, 250, 250]

[70, remaining capacity of a battery<10%, conservative, 600, 250]

[50, when connected with a power supply, ondemand, 1600, 250]

[50, when a specific app is running, interactive, 1600, 800]

[30, when a display is turned on, ondemand, 1600, 800]

[30, when a display is turned off, ondemand, 600, 250]

Here, if a user explicitly sets a mode to a high-performance mode or a low-power mode, as shown in the operation setting information in Embodiment 2, because the precedence values of the first two conditions are 100, the first two conditions have precedence over the other conditions. Accordingly, the governor control unit 130 may run a performance governor or a power-save governor, which satisfies the condition.

Here, if a user does not explicitly set the mode, the condition having the second-highest precedence value may be checked. Accordingly, the remaining capacity of a battery is checked, and if the remaining capacity of the battery is less than 10%, the governor control unit 130 may run a conservative governor. Here, the maximum frequency and the minimum frequency may be set to 600 and 250, respectively. That is, if the remaining capacity of the battery is less than 10%, the governor control unit 130 may run the conservative governor that activates only the little-core cluster.

If the remaining capacity of the battery is equal to or greater than 10%, the governor control unit 130 may check the operation condition having the next-highest precedence value. If a power supply is connected, the governor control unit 130 may run an ondemand governor at frequency of 250 to 1600 MHz. Also, when a specific app is running, the governor control unit 130 may run an interactive governor at frequency of 800 to 1600 MHz. Here, because the two conditions have the same precedence value, if both conditions are satisfied, the governor control unit 130 may simultaneously run the two governors corresponding thereto. When the two governors set their frequencies according to a frequency integration policy, the final frequency may be set using the frequencies set by the two governors. The governor control unit 130 may finally select the higher frequency for performance, the lower frequency for saving power, or the average thereof as the final frequency.

According to the last two conditions of Embodiment 2, the governor control unit 130 may run the ondemand governor at frequency of 800 to 1600 MHz when the display of a mobile terminal is turned on, and may run the ondemand governor at frequency of 250 to 600 MHz when the display is turned off. Accordingly, when the display is turned on, the ondemand governor that activates only the big-core cluster may be run, but when the display is turned off, the ondemand governor that activates only the little-core cluster may be run.

FIG. 4 is a block diagram that specifically shows an example of the heterogeneous core cluster unit illustrated in FIG. 1.

Referring to FIG. 4, the heterogeneous core cluster unit 110 may include a first core cluster unit 111 and a second core cluster unit 112.

The first core cluster unit 111 may be a big-core cluster.

The first core cluster unit 111 may include multiple cores.

Here, the big-core cluster may include multiple big cores 11, 12, 13 and 14.

Here, the big-core cluster may perform high-performance operation.

The second core cluster unit 112 may be a little-core cluster.

The second core cluster unit 112 may include multiple cores.

Here, the little-core cluster may include multiple little cores 21, 22, 23 and 24.

Here, the little-core cluster may perform low-power operation.

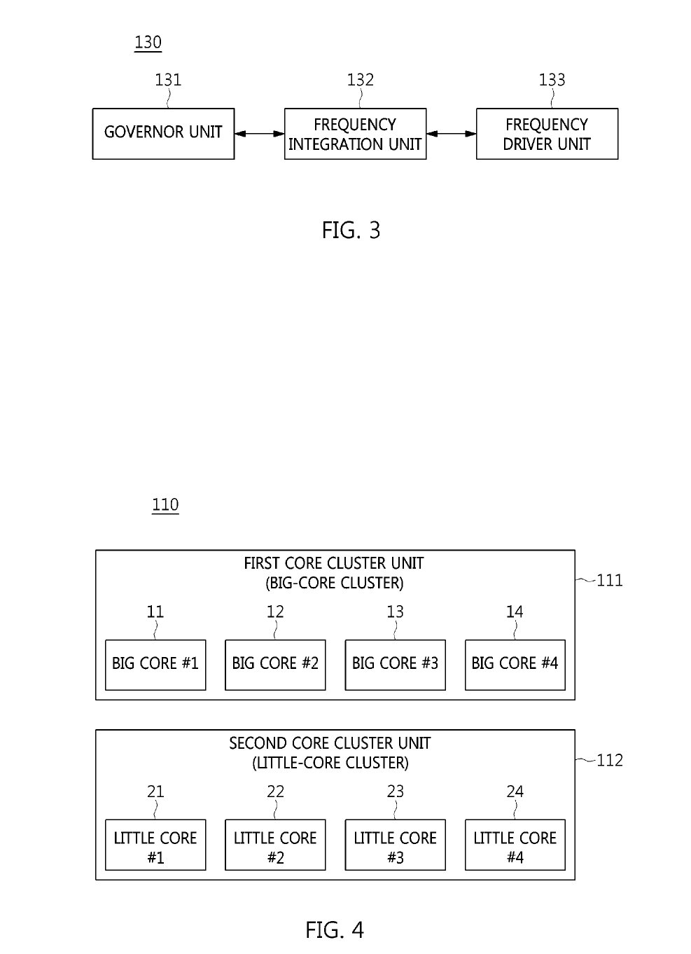

FIG. 3 is a block diagram that specifically shows an example of the governor control unit illustrated in FIG. 1.

Referring to FIG. 3, the governor control unit 130 may include a governor unit 131, a frequency integration unit 132, and a frequency driver unit 133.

The governor unit 131 may include at least one of a performance governor for running a core with the highest performance, a powersave governor for reducing power consumption to a minimum by running a core at the lowest frequency, an ondemand governor for dynamically regulating a frequency by raising an operating frequency when a CPU load increases but lowering the operating frequency when the CPU load decreases, an interactive governor for improving responsiveness to user input, and a conservative governor for decreasing the responsiveness lower than a request mode and for saving energy.

The frequency integration unit 132 may set the minimum frequency and maximum frequency of the at least one governor selected from the governor unit 131 according to a frequency integration policy.

Here, the frequency integration unit 132 may set the final frequency to a high frequency for performance, a low frequency for power savings, or the average frequency.

The frequency driver unit 133 may run the first core cluster unit 111 and the second core cluster unit 112 of the heterogeneous core cluster unit 110 by controlling the frequency thereof using the final frequency set by the frequency integration unit 132.

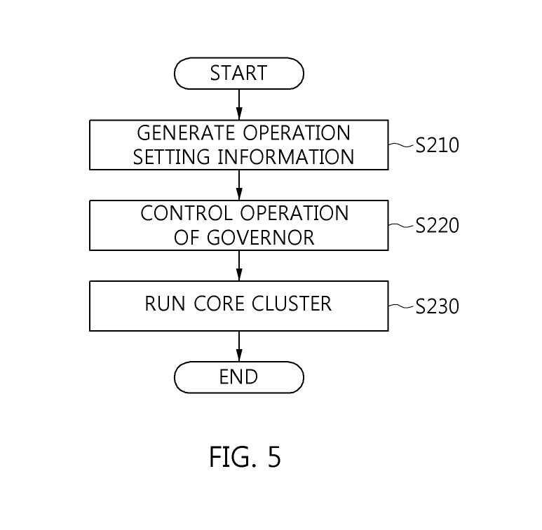

FIG. 5 is a flowchart that shows a method for controlling a governor based on a heterogeneous multicore system according to an embodiment of the present invention.

Referring to FIG. 5, in the method for controlling a governor based on a heterogeneous multicore system according to an embodiment of the present invention, first, operation setting information may be generated at step S210.

That is, at step S210, the operation setting information of a governor for controlling the operation of the first core cluster unit 111 and the second core cluster unit 112 of the heterogeneous core cluster unit 110 may be generated.

Here, at step S210, operation setting information in which at least one of a precedence value, an operation condition, an operation governor, the maximum frequency, and the minimum frequency is set may be generated.

Here, at step S210, the precedence values of operation conditions for at least one of an operation mode set by a user, a remaining capacity of a battery, information about whether a power supply is connected, information about whether an application is running, and information about whether a display is turned on may be set.

Here, at step S210, the maximum frequency and the minimum frequency may be set on each of the operation conditions, the precedence value of which is set.

Here, at step S210, operation setting information, configured as shown in Embodiment 1, may be input from a user.

Also, in the method for controlling a governor based on a heterogeneous multicore system according to an embodiment of the present invention, the operation of a governor may be controlled at step S220.

That is, at step S220, the operation of one or more governors may be controlled based on the operation setting information.

Here, at step S220, at least one of a performance governor for running a core with the highest performance, a powersave governor for reducing power consumption to a minimum by running a core at the lowest frequency, an ondemand governor for dynamically regulating a frequency by raising an operating frequency when a CPU load increases but lowering the operating frequency when the CPU load decreases, an interactive governor for improving responsiveness to user input, and a conservative governor for decreasing the responsiveness lower than a request mode and for saving energy may be controlled.

Here, at step S220, the minimum and maximum frequencies of the one or more governors, selected from the governor unit 131, may be set according to the frequency integration policy.

Here, at step S220, the higher frequency may be set as the final frequency for performance, the lower frequency may be set as the final frequency for saving power, or the average frequency may be set as the final frequency.

Here, at step S220, an operation condition is selected depending on the precedence value set in the operation setting information, and an operation governor corresponding to the operation condition may be run.

Here, at step S220, if two or more operation conditions have the same precedence value, operation governors corresponding to the two or more operation conditions are simultaneously run, and the final frequency may be set according to the frequency integration policy.

Here, at step S220, if two or more operation conditions have the same precedence value, the maximum value of the maximum frequencies of the two or more operation conditions and the minimum value of the minimum frequencies thereof may be set as the final frequencies according to the frequency integration policy.

Here, at step S220, if two or more operation conditions have the same precedence value, the maximum value of the maximum frequencies of the two or more operation conditions and the maximum value of the minimum frequencies thereof may be set as the final frequencies according to the frequency integration policy.

Here, at step S220, if two or more operation conditions have the same precedence value, the average of the maximum frequencies of the two or more operation conditions and the average of the minimum frequencies thereof may be set as the final frequencies according to the frequency integration policy.

Also, in the method for controlling a governor based on a heterogeneous multicore system according to an embodiment of the present invention, a core cluster may be run at step S230.

That is, at step S230, the first core cluster unit 111 and the second core cluster unit 112 of the heterogeneous core cluster unit 110 may be run by controlling the frequencies thereof using the final frequencies set depending on the operation setting information.

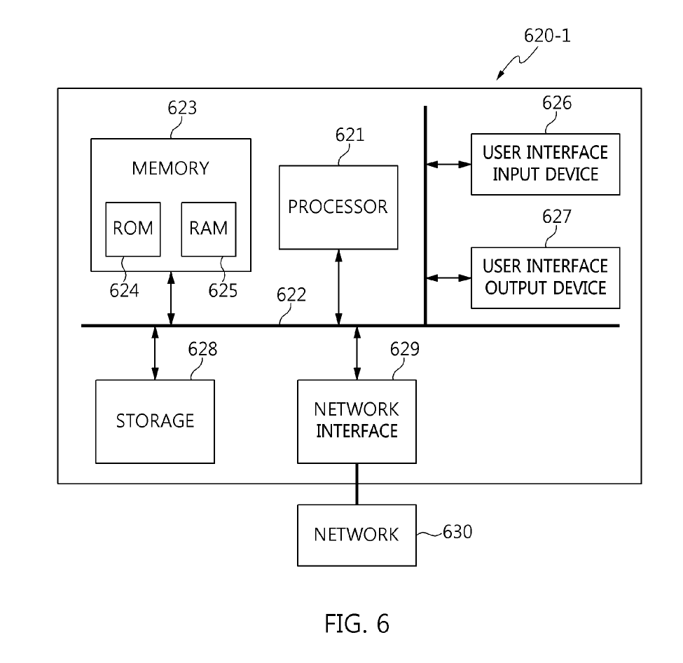

An embodiment of the present invention may be implemented in a computer system, e.g., as a computer readable medium. As shown in FIG. 6, a computer system 620-1 may include one or more of a processor 621, a memory 623, a user interface input device 626, a user interface output device 627, and a storage 628, each of which communicates through a bus 622. The computer system 620-1 may also include a network interface 629 that is coupled to a network 630. The processor 621 may be a central processing unit (CPU) or a semiconductor device that executes processing instructions stored in the memory 623 and/or the storage 628. The memory 623 and the storage 628 may include various forms of volatile or non-volatile storage media. For example, the memory may include a read-only memory (ROM) 624 and a random access memory (RAM) 625.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The present invention may efficiently control and manage multiple governors using various kinds of information.

Also, the present invention may improve the performance of a multicore system by minimizing the number of operations for switching between core clusters.

Also, the present invention may reduce the amount of power consumed by a multicore system by minimizing the number of operations for switching between core clusters.

As described above, the apparatus and method for controlling a governor based on a heterogeneous multicore system according to the present invention are not limitedly applied to the configurations and operation of the above-described embodiments, but all or some of the embodiments may be selectively combined and configured, so that the embodiments may be modified in various ways.

What is claimed is:

1. An apparatus for controlling a governor based on a heterogeneous multicore system, comprising:
a heterogeneous core cluster unit for running any one of a first core cluster for high-performance operation and a second core cluster for low-power operation by switching therebetween;
a governor-setting unit for generating operation setting information of a governor for controlling operation of the first core cluster and the second core cluster; and
a governor control unit for controlling operation of one or more governors based on the operation setting information.

2. The apparatus of claim 1, wherein the governor-setting unit generates the operation setting information in which at least one of a precedence value, an operation condition, an operation governor, a maximum frequency, and a minimum frequency is set.

3. The apparatus of claim 2, wherein the governor-setting unit sets the precedence value on the operation conditions for at least one of an operation mode set by a user, a remaining capacity of a battery, information about whether a power supply is connected, information about whether an application is running, and information about whether a display is turned on.

4. The apparatus of claim 3, wherein the governor-setting unit sets the maximum frequency and the minimum frequency on each of the operation conditions, the precedence value of which is set.

5. The apparatus of claim 4, wherein the governor control unit determines an operation condition depending on the precedence value set in the operation setting information and runs an operation governor corresponding to the operation condition.

6. The apparatus of claim 5, wherein the governor control unit controls any one of the first core cluster and the second core cluster at between the maximum frequency and the minimum frequency by running the operation governor corresponding to the operation condition.

7. The apparatus of claim 6, wherein, when two or more operation conditions have an identical precedence value, the governor control unit simultaneously runs operation governors corresponding to the two or more operation conditions and sets a final frequency according to a frequency integration policy.

8. The apparatus of claim 7, wherein, when two or more operation conditions have an identical precedence value, the governor control unit sets a maximum value of maximum frequencies of the two or more operation conditions and a minimum value of minimum frequencies of the two or more operation conditions as final frequencies according to the frequency integration policy.

9. The apparatus of claim 7, wherein, when two or more operation conditions have an identical precedence value, the governor control unit sets a maximum value of maximum frequencies of the two or more operation conditions and a maximum value of minimum frequencies of the two or more operation conditions as final frequencies according to the frequency integration policy.

10. The apparatus of claim 7, wherein, when two or more operation conditions have an identical precedence value, the governor control unit sets an average of maximum frequencies of the two or more operation conditions and an average of minimum frequencies of the two or more operation conditions as final frequencies according to the frequency integration policy.

11. A method for controlling a governor based on a heterogeneous multicore system, in which an apparatus for controlling a governor based on a heterogeneous multicore system is used, comprising:
generating operation setting information of a governor for controlling operation of a first core cluster and a second core cluster of a heterogeneous core cluster;
controlling operation of one or more governors based on the operation setting information; and
running any one of the first core cluster for high-performance operation and the second core cluster for low-power operation by switching therebetween by controlling the operation of the one or more governors.

12. The method of claim 11, wherein generating the operation setting information is configured to generate the operation setting information in which at least one of a precedence value, an operation condition, an operation governor, a maximum frequency, and a minimum frequency is set.

13. The method of claim 12, wherein generating the operation setting information is configured to set the precedence value on the operation conditions for at least one of an operation mode set by a user, a remaining capacity of a battery, information about whether a power supply is connected, information about whether an application is running, and information about whether a display is turned on.

14. The method of claim 13, wherein generating the operation setting information is configured to set the maximum frequency and the minimum frequency on each of the operation conditions, the precedence value of which is set.

15. The method of claim 14, wherein controlling the operation is configured to determine an operation condition depending on the precedence value set in the operation setting information and to run an operation governor corresponding to the operation condition.

16. The method of claim 15, wherein controlling the operation is configured to control any one of the first core cluster and the second core cluster at between the maximum frequency and the minimum frequency by running the operation governor corresponding to the operation condition.

17. The method of claim 16, wherein controlling the operation is configured such that, when two or more operation conditions have an identical precedence value, operation governors corresponding to the two or more operation conditions are simultaneously run and a final frequency is set according to a frequency integration policy.

18. The method of claim 17, wherein controlling the operation is configured such that, when two or more operation conditions have an identical precedence value, a maximum value of maximum frequencies of the two or more operation conditions and a minimum value of minimum frequencies of the two or more operation conditions are set as final frequencies according to the frequency integration policy.

19. The method of claim 17, wherein controlling the operation is configured such that, when two or more operation conditions have an identical precedence value, a maximum value of maximum frequencies of the two or more operation conditions and a maximum value of minimum frequencies of the two or more operation conditions are set as final frequencies according to the frequency integration policy.

20. The method of claim 17, wherein controlling the operation is configured such that, when two or more operation conditions have an identical precedence value, an average of maximum frequencies of the two or more operation conditions and an average of minimum frequencies of the two or more operation conditions are set as final frequencies according to the frequency integration policy.
